(19) United States
(12) Patent Application Publication
(10) Pub. No.: US 2019/0115689 A1
(43) Pub. Date: Apr. 18, 2019

(54) CONNECTOR

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Takeshi Masuda, Yokkaichi, Mie (JP); Youjirou Hashimoto, Yokkaichi, Mie (JP); Kazuo Nakai, Yokkaichi, Mie (JP); Hiromu Ootani, Yokkaichi, Mie (JP); Takehide Terasawa, Yokkaichi, Mie (JP)

(21) Appl. No.: 16/088,529

(22) PCT Filed: Mar. 21, 2017
(86) PCT No.: PCT/JP2017/011101

§ 371 Date: Sep. 26, 2018

(30) Foreign Application Priority Data
Apr. 11, 2016 (JP) 2016-078840

(51) Int. Cl. H01R 13/533; H01R 13/52; H01R 33/975

(52) U.S. Cl. CPC H01R 13/533; H01R 33/975; H01R 13/5205

(57) ABSTRACT

A connector includes a connector housing 10 including a cavity 11, a terminal 50 to be accommodated in the cavity 11 and including a wire connecting portion 53, a wire 30 connected to the wire connecting portion 53 of the terminal 50, a rubber plug 60 to be externally fit on the wire 30 and held in close contact with an inner wall of the cavity 11, and a fixing portion 70 configured to fix the wire 30 and the rubber plug 60. The wire 30 includes a flexible vibration absorbing portion 35 between a part connected to the wire connecting portion 53 and a part fixed by the fixing portion 70.

### BACKGROUND

### Field of the Invention

The invention relates to a connector.

### Description of the Related Art

Japanese Unexamined Patent Publication No. H08-96878 discloses a connector accommodating a terminal to be connected to a mating terminal for connecting an electrical device mounted in a vehicle such as an automotive vehicle. This connector prevents rattling when a male housing and a female housing are connected, by mounting a resilient body such as a rubber packing on a front end of a front holder on a connection side of the female housing.

A terminal is accommodated in the housing of this connector and is connected to a wire. The terminal and the wire are fixed by a wire barrel crimped to wind around the outer periphery of a core exposed from an end of the wire and an insulation barrel crimped to wind around an insulation coating covering the core.

However, even if rattling between the male housing and the female housing is suppressed, the vibration of a vehicle is transmitted to the wire and the vibration may be transmitted to the terminal accommodated in the connector from the wire. As a result, the terminal and a mating terminal may slide against each other. Abrasion occurs at contact points of the terminal and the mating terminal and electrical connection reliability of the terminal may be reduced.

### SUMMARY

A connector disclosed in this specification includes a connector housing including a cavity, a terminal to be accommodated in the cavity and including a wire connecting portion, a wire connected to the wire connecting portion of the terminal, a rubber plug to be fit externally on the wire and held in close contact with an inner wall of the cavity, and a fixing portion configured to fix the wire and the rubber plug. The wire includes a flexible vibration absorbing portion between a part connected to the wire connecting portion and a part fixed by the fixing portion.

According to this configuration, the wire and the rubber plug are fixed by the fixing portion and the rubber plug is held in close contact with the inner wall of the cavity. Thus, the wire is fixed in the connector housing via the rubber plug. In this way, even if vibration is transmitted to the wire from a vehicle, the vibration of the wire can be suppressed by the connector housing.

The wire includes the vibration absorbing portion between the part fixed by the fixing portion and the part connected to the wire connecting portion. This vibration absorbing portion is deflected and deformed to absorb vibration so that the vibration does not reach the wire connecting portion.

At just described, the wire has the vibration suppressed by a rigid structure in the part where the rubber plug is fit externally, and the vibration is absorbed by a flexible structure in the vibration absorbing portion. Thus, the transmission of the vibration of the wire to the terminal is suppressed, and electrical connection reliability of the terminal can be improved.

The wire may include a flexible core and an insulation coating covering the core, and the vibration absorbing portion may be formed of the core exposed from an end part of the insulation coating. In this configuration, the core exposed from the insulation coating serves as the vibration absorbing portion. Thus, vibration can be absorbed more effectively. In this way, electrical connection reliability of the terminal can be more improved.

The connector housing may include a retainer configured to come into contact with the rubber plug externally fit on the wire from a side toward which the wire is drawn out from the connector housing. According to this configuration, the rubber plug is fixed by the retainer, and the vibration of the wire can be suppressed even more suppressed.

According to the connector disclosed in this specification, the transmission of vibration from the wire to the terminal can be suppressed.

### BRIEF DESCRIPTION OF DRAWINGS

FIG. 1 is a perspective view in a state before a retaining member of a connector according to an embodiment is pushed.

FIG. 2 is a section in the state where the retaining member of the connector is pushed.

FIG. 3 is a section in a state where the retaining member of the connector is pushed.

### DETAILED DESCRIPTION

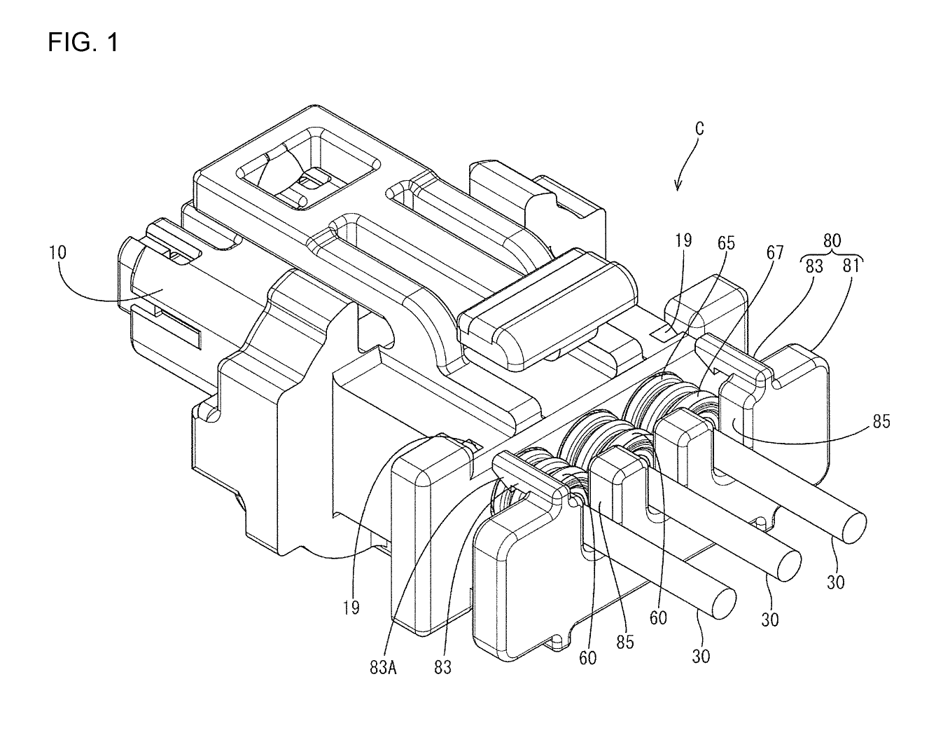

An embodiment is described with reference to FIGS. 1 to 3.

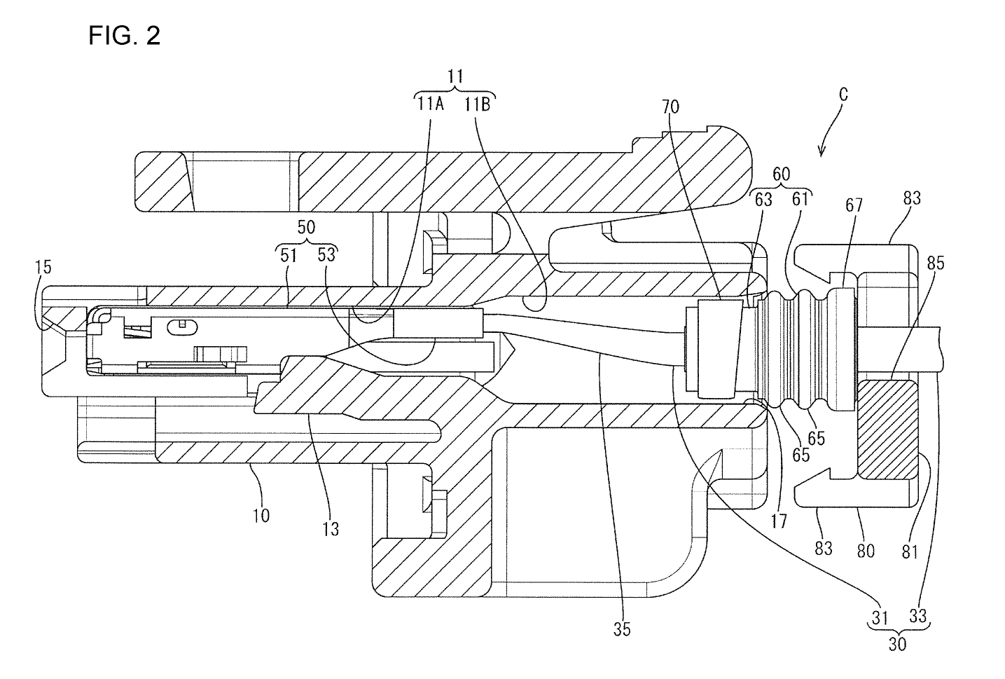

A connector C of this embodiment includes, as shown in FIGS. 1 and 2, a connector housing 10, terminals 50 connected to wires 30, rubber plugs 60 externally fit on the wires 30, fixing portions 70 for fixing the wires 30 and the rubber plugs 60 and a retainer 80 for retaining the rubber plugs 60. In the following description, a vertical direction is based on a vertical direction of FIG. 2. Further, a left side (side to be connected to a mating connector) in FIG. 2 is referred to as a front and a right side (side toward which the wires 30 are pulled out) in FIG. 2 is referred to as a rear.

The connector housing 10 is made of synthetic resin and has cavities 11 arranged side by side in a lateral direction. The terminal 50 and the wire 30 are accommodated in the cavity 11, as shown in FIG. 2. Each cavity 11 extends in a front-rear direction, with a front half serving as a terminal accommodating portion 11A for accommodating the terminal 50 and a rear half serving as a wire accommodating portion 11B for accommodating an end part of the wire 30 and the rubber plug 60. The cavity 11 is formed such that inner dimensions of the wire accommodating portion 11B are larger than those of the terminal accommodating portion 11A. The terminal accommodating portion 11A of the cavity 11 is rectangular when viewed from behind, whereas the wire accommodating portion 11B is circular when viewed from behind.

A cantilevered locking lance 13 is provided at a bottom wall of the terminal accommodating portion 11A of the cavity 11. The locking lance 13 is resiliently deformable in the vertical direction and can lock the terminal 50. An insertion opening 15 through which a mating terminal is insertable is provided in front of the cavity 11, and an opening 17 through which the wire 30 can be drawn out is provided behind the cavity 11.

As shown in FIG. 2, the wire 30 is configured such that a flexible core 31 made of a plurality of metal strands is covered by an insulation coating 33. The core 31 is deflectable in a direction intersecting an axial direction, and is covered around by the insulation coating 33.

The terminal 50 is formed by press-working and, then, bending a conductive metal plate material. As shown in FIG. 2, the terminal 50 includes a rectangular tubular connecting portion 51 to be connected to the mating terminal. A wire connecting portion 53 is connected behind the connecting portion 51 and is to be connected to the core 31 of the wire 30. The wire connecting portion 53 includes a caulking piece constituting an open barrel. This caulking piece is caulked and crimped to wind around the outer periphery of the core 31 so that the core 31 and the terminal 50 are connected. The connecting portion 51 is locked in the cavity 11 by the locking lance 13.

As shown in FIG. 2, the rubber plug 60 has a hollow cylindrical shape long in the front-rear direction, and is fit externally on the wire 30. Particularly, the rubber plug 60 is fit externally fit on a part of the wire 30 where the insulation coating 33 is provided. A center axis of the rubber plug 60 is coaxial with the terminal 50 (connecting portion 51). The rubber plug 60 includes a rubber plug body 61 and a rubber plug fixing portion 63 connected in front of the rubber plug body 61 and to be fixed by the fixing portion 70. An outer diameter of the rubber plug fixing portion 63 fixed by the fixing portion 70 is smaller than that of the rubber plug body 61.

Outwardly projecting outer peripheral lips 65 extend circumferentially around project on the outer peripheral surface of the rubber plug body portion 61 and are configured to be held resiliently in close contact with the inner peripheral wall of the wire accommodating portion 11B of the cavity 11. Each outer peripheral lip 65 has a convex-concave shape in a cross-section and is formed over the entire circumference. When the rubber plug 60 is fit into the wire accommodating portion 11B, a top part of each outer peripheral lip 65 is pressed and squeezed by the inner peripheral wall of the wire accommodating portion 11B to be held in close contact with the inner peripheral wall. Thus, the rubber plug 60 provides sealing between the outer peripheral surface of the wire 30 and the inner peripheral wall of the wire accommodating portion 11B.

A rear end part of the rubber plug body 61 serves as a large-diameter portion 67 to be fit tightly into a rear end part of the wire accommodating portion 11B behind the outer peripheral lips 65, thereby preventing a clearance from being formed between the inner peripheral wall of the wire accommodating portion 11B and the outer peripheral lips 65 even if the wire 30 drawn out rearwardly from the rubber plug 60 is bent.

The fixing portion 70 is a plate-like member made of metal and is in the form of an open barrel. The fixing portion 70 is caulked (crimped) to wind around the outer periphery of the rubber plug fixing portion 63 of the rubber plug 60 to fix the rubber plug 60 and the wire 30.

The retainer 80 is made of synthetic resin and, as shown in FIGS. 1 and 2, covers the rear surface of the connector housing 10 and the opening 17. Further, the retainer 80 is mounted into contact with the rubber plugs 60 from a side toward which the wires 30 are drawn out (from behind). The retainer 80 includes a retaining body 81 in the form of a flat plate and locking portions 83 to be locked to the connector housing 10. The retaining body 81 is rectangular when viewed from behind, and restricts rearward movements of the rubber plugs 60 by the contact of the rear surfaces of the rubber plugs 60 and the front surface of the retaining body 81. Further, the retaining body 81 has insertion grooves 85 for allowing the insertion of the wires 30. The insertion grooves 85 are provided by cutting the retaining body 81 into grooves from an upper edge to vertical center positions. An inner dimension of each insertion groove 85 in a width direction is equal to or slightly smaller than an outer diameter of the wire 30.

Two of the locking portions 83 are provided on each of the upper and lower edges of the retaining body 81, i.e. a total of four locking portions 83 are provided. The locking portions 83 extend forward from the upper and lower edges of the retaining body 81 and tips of the locking portions 83 have locking claws 83A projecting toward the connector housing 10. The locking claws 83A are locked to locking recesses 19 on the connector housing 10. The locking recesses 19 are provided on a rear end part of the connector housing 10 and are recessed inward of the connector housing 10 in conformity with the shape of the locking claws 83A. The locking claws 83A are locked to the locking recesses 19 to lock the retaining member 80 to the connector housing 10.

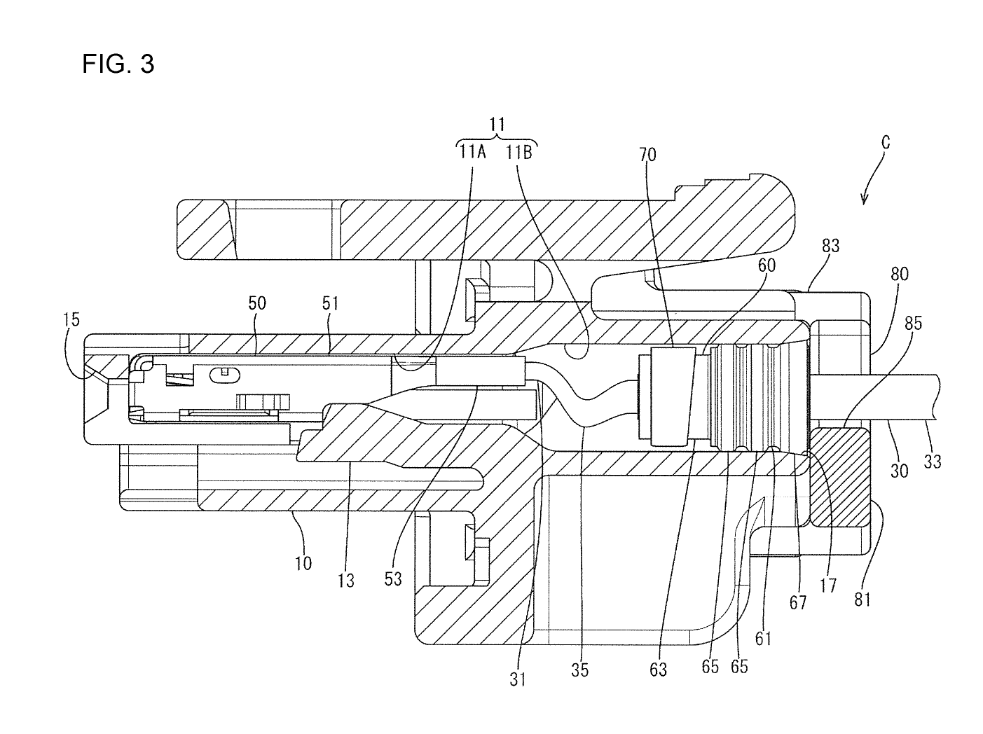

As shown in FIGS. 2 and 3, the wire 30 is formed with a flexible vibration absorbing portion 35 by stripping the insulation coating 33 from a position where the terminal 50 is connected to a position where the rubber plug 60 is to be fit externally to expose the core 31. The vibration absorbing portion 35 is not covered by the insulation coating 33. Thus, the vibration absorbing portion 35 is deflected more easily than a part of the wire 30 covered by the insulation coating 33. A length of the vibration absorbing portion 35 in the front-rear direction is longer than a dimension between the wire connecting portion 53 of the terminal 50 and the rubber plug 60. Thus, when the terminal 50 and the rubber plug 60 are disposed at proper positions, the vibration absorbing portion 35 is deflected in a direction intersecting the front-rear direction (extending direction of the wire 30).

The connector C of this embodiment is configured as described above. Next, how to assemble the connector C and functions of the connector C are described.

First, the insulation coating 33 is stripped on the end part of the wire 30. At this time, the insulation coating 33 is stripped more than usual to expose the core 31 up to a position before the position where the rubber plug 60 is to be mounted to form the vibration absorbing portion 35 on the wire 30.

The rubber plug 60 is mounted on the wire 30 in advance and is fit externally on the wire 30 at a position where a front end of the insulation coating 33 and a front end of the rubber plug 60 are aligned. The fixing portion 70 then is caulked to wind around the outer periphery of the rubber plug fixing portion 63, thereby fixing the wire 30 and the rubber plug 60. Note that the wire 30 and the rubber plug 60 are fixed firmly by the fixing portion 70 to such an extent that the wire 30 and the rubber plug 60 do not move relative to each other.

Then, the terminal 50 is crimped and connected to the end of the exposed core 31 of the wire 30 by caulking the wire connecting portion 53 of the terminal 50 to the core 31. Subsequently, the wire 30 having the terminal 50 mounted thereon is inserted through the retaining member 80. The wire 30 extending rearward of the rubber plug 60 is inserted into the insertion groove 85 from above such that the rear end surface of the rubber plug body 61 (rear end surface of the large-diameter portion 67) contacts the front surface of the retaining body 81, and is pulled rearward of the retainer 80.

Subsequently, as shown in FIGS. 1 and 2, the terminals 50 having the wires 30 connected thereto are accommodated into the connector housing 10. The locking lance 13 locks the terminal 50 that reaches a proper position in the terminal accommodating portion 11A of the cavity 11. On the other hand, the rubber plug body 61 of the rubber plug 60 is located behind the proper position by a redundant part (length for deflection) of the vibration absorbing portion 35. More specifically, the rubber plug body 61 is located behind and outwardly of the cavity 11 of the connector housing 10 and is exposed rearward from the opening 17. Further, the retainer 80 also is located behind the proper position in accordance with the positions of the rubber plugs 60.

In this state (state of FIG. 2), the retaining member 80 is pushed forward to be mounted on the connector housing 10, as shown in FIG. 3. When the retainer 80 is pushed forward, the rubber plug bodies 61 pushed by the retaining body 81 are pushed into the wire accommodating portions 11B of the cavities 11 of the connector housing 10, and the outer peripheral lips 65 are held in close contact with the inner walls of the wire accommodating portions 11B of the cavities 11. Further, the large-diameter portions 67 also are held in close contact with the inner walls of the rear end parts of the cavities 11. On the other hand, the cores 31 (vibration absorbing portions 35) exposed from the insulation coatings 33 are deflected in the wire accommodating portions 11B of the cavities 11. The locking claws 83A of the locking portions 83 of the retaining member 80 then are locked to the locking recesses 19 of the connector housing 10, as shown in FIG. 1, to mount the retaining member 80 on the connector housing 10.

In this way, the rubber plugs 60 fixed to the wires 30 by the fixing portions 70 are held in close contact with the inner walls of the wire accommodating portions 11B of the cavities 11 of the connector housing 10. Further, the rubber plugs 60 are fixed so as not to come out of the cavities 11 by the retainer 80 contacting the rubber plugs 60 from behind. Thus, the wires 30 are fixed in the connector housing 10 via the rubber plugs 60. Externally generated vibration that might affect the wire 30 is suppressed since the wire 30 is fixed in the connector housing 10 via the rubber plug 60.

Further, the wire 30 is provided with the vibration absorbing portion 35 between the part fixed to the rubber plug 60 by the fixing portion 70 and the part connected to the wire connecting portion 53 of the terminal 50. This vibration absorbing portion 35 is flexible and absorbs vibration by being deflected and deformed. Thus, the vibration is suppressed before reaching the wire connecting portion 53.

As described above, in the connector C of this embodiment, vibration transmitted to the wire 30 from outside is suppressed before reaching the terminal 50. The wire 30 has the vibration suppressed by a rigid structure in the part where the rubber plug 60 is fit externally (part fixed to the rubber plug 60 by the fixing portion 70). Further, the vibration is absorbed by a flexible structure in the vibration absorbing portion 35. That is, the transmission of the vibration is suppressed by a double structure composed of the rigid structure and the flexible structure. This suppression of the transmission of the vibration from the wire 30 to the terminal 50 improves electrical connection reliability of the terminal 50.

The invention is not limited to the above described and illustrated embodiment. For example, the following modes are also included.

Although the retaining member 80 is provided in the above embodiment, the retainer 80 may not be provided.

Although the vibration absorbing portion 35 is formed of the core 31 exposed from the end part of the insulation coating 33 in the above embodiment, the insulation coating may not be stripped if the vibration absorbing portion is flexible. Further, the vibration absorbing portion 35 may be formed of another flexible material such as a braided wire.

The fixing portion 70 fixes the rubber plug 60 by winding a plate-like member made of metal and in the form of an open barrel around the outer periphery of the rubber plug 60 in the above embodiment. However, the rubber plug 60 may be fixed by fitting a C-ring or the like on the outer periphery. Further, the rubber plug may be fixed by mounting a fixing member between the rubber plug and the wire or the rubber plug may be formed by double molding to make a fixing part harder and fixed to the wire 30.

### LIST OF REFERENCE SIGNS

10: connector housing
11: cavity
11A: terminal accommodating portion
11B: wire accommodating portion
13: locking lance
19: locking recess
30: wire
31: core
33: insulation coating
35: vibration absorbing portion
50: terminal
51: connecting portion
53: wire connecting portion
60: rubber plug
70: fixing portion
80: retaining member
83: locking portion
C: connector

1. A connector, comprising:
a connector housing including a cavity;
a terminal to be accommodated in the cavity and including a wire connecting portion;
a wire connected to the wire connecting portion of the terminal;
a rubber plug to be fit externally on the wire and including a rubber plug body provided with an outer peripheral lip to be held in close contact with an inner wall of the cavity; and
a fixing portion configured to fix the wire and the rubber plug,
the wire including a flexible vibration absorbing portion between a part connected to the wire connecting portion and a part fixed by the fixing portion;
the rubber plug including a rubber plug fixing portion connected in front of the rubber plug body in a pushing direction of the rubber plug into the cavity and to be fixed by the fixing portion; and
an outer diameter of the rubber plug fixing portion in a state fixed by the fixing portion being smaller than an outer diameter of the rubber plug body.

2. The connector of claim 1, wherein:
the wire includes a flexible core and an insulation coating covering the core; and
the vibration absorbing portion is formed of the core exposed from an end part of the insulation coating.

3. The connector of claim 2, wherein the connector housing includes a retain configured to contact the rubber plug that is externally fit on the wire from a side toward which the wire is drawn out from the connector housing.

4. The connector of claim 1, wherein the connector housing includes a retainer configured to contact the rubber plug that is externally fit on the wire from a side toward which the wire is drawn out from the connector housing.
